(19) United States
(12) Patent Application Publication
(10) Pub. No.: US 2008/0098380 A1
(43) Pub. Date: Apr. 24, 2008

(54) SYSTEM, METHOD, AND DEVICE FOR UPDATING PROGRAMMABLE ELECTRONIC EQUIPMENT WITH A TRANSPORT DEVICE FROM A DEPLOYMENT SERVER VIA THE INTERNET OR OTHER COMMUNICATION MEDIUM

(76) Inventor: Toby Klusmeyer, Windsor, WI (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/550,645

(22) Filed: Oct. 18, 2006

(51) Int. Cl. G06F 9/44

(52) U.S. Cl. 717/168

(57) ABSTRACT

A method, system, and device for updating and debugging the firmware of a microcontroller or FPGAs resident on PCB assemblies contained within OEM machines is disclosed. The system comprises a portable, configurable transport device with two interface adapters. The first adapter is a programming adapter for interfacing the device with a programming interface port, such as JTAG; ISP, SPI, or debugWIRE of a microcontroller to enable the deployment of firmware to OEM equipment. The second adapter is one commonly used for interfacing a remote deployment server such as a web or file server. It may be interfaced with a personal computer, such as USB, firewire, printer, serial, WIFI, or Ethernet connections or may contain any physical interface to connect directly to the deployment server.

### FIELD OF THE DISCLOSURE

The present disclosure relates to the field of updating programmable electronic equipment. More specifically, the present invention relates to updating programmable electronic equipment having electronic devices with a resident programming interface and protocol.

### BACKGROUND OF THE DISCLOSURE

JTAG, an acronym for Joint Test Action Group, is the name used for the IEEE 1149.1 standard entitled “Standard Test Access Port and Boundary-Scan Architecture”, for test access ports used for testing printed circuit boards using boundary scan.

JTAG was standardized in 1990 as the IEEE Std. 1149.1-1990. In 1994, a supplement that contains a description of the boundary scan description language (BSDL) was added. Since then, this standard has been adopted by electronics companies all over the world. Boundary-scan is presently synonymous with JTAG.

While designed for printed circuit boards, JTAG is primarily used for testing sub-blocks of integrated circuits, and is also useful as a mechanism for debugging embedded systems, providing convenient access into the system. When used as a debugging tool, an in-circuit emulator which in turn uses JTAG as the transport mechanism enables a programmer to access an on-chip debug module which is integrated into the CPU via JTAG. The debug module enables the programmer to debug the software of an embedded system and to program its internal non-volatile memory if available.

The JTAG physical interface is a special four/five-pin interface added to a chip and designed so that multiple chips on a board can have their JTAG lines daisy-chained together, and a test probe need only connect to a single “JTAG port” to have access to all chips on a circuit board. The connector pins of the JTAG include TDI (Test Data In); TDO (Test Data Out); TCK (Test ClocK); TMS (Test Mode Select); and TRST (Test ReSeT), which is optional. Since only one data line is available, the protocol is necessarily serial. The clock input is the TCK pin. Configuration is performed by manipulating a state machine one bit at a time through a TMS pin. One bit of data is transferred in and out per TCK clock pulse at the TDI and TDO pins, respectively. Different instruction modes can be loaded to read the chip ID, sample input pins, drive (or float) output pins, reset the chip, read and write registers and memory, and manipulate chip functions, or bypass (pipe TDI to TDO to logically shorten chains of multiple chips) to other JTAG devices connected to the serial chain.

Many OEM products provide a JTAG port interface and it is probable that the interface connector remains on the product for the purpose of updating the firmware on the product with a JTAG programmer.

The USB port is a well known interface used commonly on personal computers (PCs). Many devices have USB interfaces. When connected to a USB port, the device may be controlled by the host computer to perform a variety of functions. Generally, a simple set of instructions are exchanged between the host computer and the device resulting with the desired set of functions performed.

A common device used today is the USB memory device which is connected to a computer through its USB port. It is referred to with names like flash-drive, thumb-drive, jump-drive, etc. The device is connected to a computer through its USB port. The USB memory device serves as a detachable file system and retains data for the purpose of transferring data from host to host or backing up data. Data is transferred to the USB memory device from the host computer for short or long term storage. The USB memory device can be removed from the host without loss of data and can retain the data contents for several years without being powered.

There are several types of portable memory devices that perform the function of storing data in a non-powered state. These devices use non-volatile memory storage technologies to retain data. Examples of non-volatile memory technology include flash memory, magnetic media or EEprom memory. The memory contents of some non-volatile devices can be modified many times throughout the memory device's operating life. There are numerous types and brands of devices differentiated by various shapes and sizes, memory size, unique electronic interfaces, various connector interfaces and software driver requirements.

Many of today's Computer controlled OEM equipment contain very simple microcontrollers, microprocessors, very complicated computer electronics or even remotely connected computer systems. In all cases, the computers are controlled by software/data that is stored in non-volatile memory accessible by the OEM computer system. It is often necessary to change the software/data for the purpose of changing the machine's functional performance. There are many methods for changing the software/data or firmware.

In older OEM equipment, the non-volatile memory was often read-only (not writable) and was in the form of a removable memory IC that could be removed and replaced when a firmware update was necessary. Whereas, in newer OEM equipment, the memory is often rewriteable. Therefore, it is unnecessary to replace parts in order to update the machine's firmware. In all OEM equipment, a firmware update requires a method by which the developer must transfer the new firmware into the OEM equipment (firmware deployment).

One method that firmware is traditionally deployed is by programming a non-volatile memory IC, physically sending it to the location of the OEM machine, and physically installing it onto a circuit board that provides a socket where the memory IC is placed. Another method is performed by programming the non-volatile memory electronic device, and physically sending it to the location of the OEM machine, and physically attaching it to the machine, upon which the machine recognizes the attachment (automatically or manually), and transfers the firmware to the non-volatile program or memory space of the machine. This method requires that the OEM machine is previously physically configured and programmed to recognize the electronic device attachment.

Firmware may also be installed when the OEM machine is hard-wired into a network, whereby firmware can be installed onto it through that connection. The network may be local or connected world wide through media such as the internet, telephony networks, radio, or satellite.

As discussed above, the OEM machine may have a JTAG interface, but may also have other programming interfaces such as BDM (Background Debug Mode), serial ISP, serial SPI or debugWIRE, serial UART with bootloader, among others known in the art.

### SUMMARY OF THE DISCLOSURE

A method, system, and device for updating and debugging the firmware of a microcontroller or FPGAs resident on PCB assemblies contained within OEM machines is disclosed. The system comprises a portable, configurable transport device with two interface adapters. The first adapter is a programming adapter for interfacing the device with a programming interface port, such as JTAG; ISP, SPI, or debugWIRE of a microcontroller to enable the deployment of firmware to OEM equipment. The second adapter is one commonly used for interfacing a remote deployment server such as a web or file server. It may be interfaced with a personal computer, such as USB, firewire, printer, serial, WIFI, or Ethernet connections or may contain any physical interface to connect directly to the deployment server.

One aspect of the present disclosure is a system for deploying firmware updates to an OEM machine, the system comprises a transport device including: a first port, a second port, and a non-volatile memory and an electronic device configured to access and retrieve a firmware update, wherein the first port of the transport device is configured to interface with the electronic device, and further wherein the electronic device is configured to transfer the firmware update to the non-volatile memory through the first port when the transport device is removably coupled to the electronic device, wherein the second port is configured to interface with the OEM machine, such that when the transport device is decoupled from the electronic device and coupled to the OEM machine, the firmware update is transferred to the OEM machine. The transport device of the system further includes a processor or state-machine electronics configured to facilitate the retrieval and transfer of the firmware update from the electronic device to the OEM machine and the electronic device may be configured to access a network. This network may be any of: the internet; a wide area network; and a local area network wherein the electronic device accesses the firmware update through the network. The system further comprises any one of a deployment server; a web server, a file server configured to provide the firmware update to the electronic device and wherein the electronic device may be an internet enabled device or a wireless data device. The first port of the system is any one of a USB port; a firewire port; a printer port; a serial port, a powered ethernet port and a phone port and wherein the second port is any one of a JTAG; an ISP, a SPI; a BDM, a resident bootloader, a serial UART, and a debugWIRE port and wherein the transport device is further configured to update a programmable device or a field programmable gate array and further wherein the transport device is remotely configurable to change its function.

A second aspect of the present disclosure is a method of deploying firmware updates to an embedded processing machine, the method comprises retrieving a firmware update with an electronic device, connecting a transport device to the electronic device with a first port, transferring the firmware update to the transport device through the first port, disconnecting the transport device from the electronic device, connecting the transport device to an OEM machine with a second port, and transferring the firmware update to the OEM machine through the second port. The method further wherein the transport device further includes one of a processor or state machine electronics configured to facilitate the retrieval and transfer of the firmware update from the electronic device to the OEM machine and wherein the retrieving step includes the electronic device accessing a network wherein the network is any of: the internet; a wide area network; and a local area network. The electronic device of the method retrieves the firmware update from any one of a deployment server; a web server; a file server and the electronic device may be an internet enabled device or a wireless data device. The method further wherein the first port is any one of a USB port; and a firewire port; a printer port; a serial port; a powered ethernet port; and a phone port, the second port is any one of a JTAG; an ISP; a SPI; a BDM; a resident bootloader; a serial UART; and a debugWIRE port wherein the transport device is further configured to update a programmable device or a field programmable gate array and is remotely configurable to change its function.

Another aspect of the present disclosure is a transport device for deploying a firmware update to an OEM machine, the transport device comprises a first port configured for coupling to a network service media, such that when the first port is coupled to the network service media, a firmware update is transferred from a deployment server such as a web server to the transport device, a non-volatile memory coupled to the first port, and configured to receive the firmware update from the network service media through the first port, a second port coupled to the non-volatile memory, and configured to couple with an OEM machine, such that when the transport device receives the firmware update, the transport device is decoupled from the network service media, and coupled to the OEM machine, further wherein the transport device transfers the firmware update from the non-volatile memory device to the OEM machine through the second port, and any of a processor or state-machine electronics configured to facilitate the transfer of the firmware update from the electronic device to the OEM machine, wherein the processor or state-machine electronics remotely configurable to employ any one of a JTAG; an ISP; a SPI; a BDM; and a debugWIRE port.

Yet another aspect of the present disclosure is a transport device for deploying a diagnostic test routine onto an OEM machine, the transport device comprises a first port configured for coupling to an electronic device, such that when the first port is coupled to the electronic device, a diagnostic test program is transferred from the electronic device to the transport device, a non-volatile memory coupled to the first port, and configured to receive the diagnostic test software from the electronic device through the first port, a second port configured for coupling to a JTAG port coupled to the non-volatile memory, and further configured to couple with an OEM machine, such that when the transport device receives the diagnostic test software update, the transport device is decoupled from the electronic device, and coupled to the OEM machine, further wherein when the transport device is coupled to the OEM machine, transport device invokes the diagnostic test routines held within the transport device and performs a set of tests upon the OEM machine through the second port using a JTAG protocol resident on the OEM machine, and any of a processor or state-machine electronics configured to facilitate the execution of the diagnostic test software resident in non-volatile memory through the second port when attached to the OEM machine.

### BRIEF DESCRIPTION OF THE DRAWINGS

FIG. 1 is a block diagram of an embodiment of a firmware deployment method.

FIG. 2 is a flowchart of an embodiment of a firmware deployment method.

FIG. 3 is a graphical representation of an embodiment of a firmware deployment system.

FIG. 4 is a block diagram of an embodiment of a firmware deployment device.

### DETAILED DESCRIPTION

A method, system and device for updating and debugging the firmware of a microcontroller or FPGA is disclosed. The system comprises a portable transport device with two data transport adapters, a host (internal or external to the transport device), a network connection to a remote host, and a deployment server residing on the remote host.

The transport device is a portable device, powered internally or externally, and is comprised of two adapters. The first adapter is hardware and software configured as a programming adapter for the deployment of firmware updates onto systems with reprogrammable devices such as microcontrollers or FPGAs. The second adapter is hardware and software configured to receive firmware updates from a local or remote deployment server. The transport device may contain the software and hardware interface necessary to connect directly to the communication medium that connects to the remote deployment server.

The communication network is generally the internet and provides the interconnection between the transport device and the deployment server. The communication mediums include but are not limited to cable, wireless, satellite, and telephone networks. The service may be provided by the internet or other networks commercially available for connecting a deployment server to a remote device.

The deployment server is generally a web or file server and its purpose is to communicate and provide services to a remotely connected transport device. Services include but are not limited to the transfer of firmware and data updates to and from the transport device.

An exemplary system is comprised of a transport device with its first port configured as a JTAG interface port. It is configured to program electronic equipment having programmable devices with a resident JTAG interface control unit and the physical interface connector. The second port is configured as a USB interface port and is configured to interface and communicate with a personal computer (PC) that is connected to a remote web server. In this example, the transport device is connected to a web server by means of a network comprised of the transport device's USB port, the host PC, and the internet connection of the PC to the remote web server.

The remote deployment server provides services to the transport device. Services include but are not limited to transferring firmware updates and data to and from the transport device.

After the transport device has received the firmware update from the deployment server, it is physically removed from the network connection. It retains the transferred firmware in its non-volatile memory. The transport device is physically delivered to the Programmable Equipment in need of a firmware update. The JTAG interface connector of the Programmable Equipment is identified and the transport device's first port described above is attached to it. Upon being powered internally or externally, the transport device downloads the firmware into the non-volatile memory of the Programmable Equipment through the JTAG interface and required protocol.

Programming interfaces like JTAG are those that have been provided by the manufacturer of the programmable device, is resident within the programmable device, and can be one of many protocols and physical interfaces. Examples of resident programmable interfaces include JTAG, BDM (Background Debug Mode), SPI, ISP, serial interfaces with resident bootloaders, and debugWIRE. Many electronic systems have been installed in remote locations that need to have firmware updates made to them. Many of these systems have interface connectors and resident programming interfaces present for the requirement of future updates. This method, system and transport device provides an efficient, low cost solution for updating firmware onto these systems. This method, system, and device eliminates costly programmers, significantly reduces the time for firmware deployment, is repeatable, requires very little technical skill, and eliminates shipping costs for repeated firmware updates.

In addition to updating firmware onto programmable equipment, this method, system and device provides a means to transfer collected data from the equipment to the deployment server.

An electronic system with a resident JTAG interface can be diagnosed with this invention simply by programming the transfer device to use the resident JTAG interface to manipulate the hardware of the electronic system to determine if it is operating correctly. In this case, the diagnostic program would have to be customized to work with the electronic system of interest.

The method, system and device employs a cost effective and efficient way to deploy firmware onto programmable electronic equipment. The transport device includes two data transport adapter ports. The first port is a computer interface port. The second port is preferably a JTAG port, but may be any other state-machine resident programming interface known in the art such as BDM, SPI, ISP, debugWIRE or an interface with a resident bootloader. In this embodiment, for ease of description, this port is referred to as the JTAG port. The first port provides the capability of connecting to a standard PC or computing device that is connected to a web or file server through the internet or other transport media. This amplifies the device's portability by providing the ability to transfer the firmware to the device from any remote location. The first connector is preferably a USB port, and the second port is preferably a standard 6 or 10 pin connector with pinouts confirming to the JTAG standard pinout for specific microcontrollers in the industry. For interfaces other than JTAG, the connector and pinouts for the second port depends on the implementation and requirements of each of the programming interfaces in the art (BDM, ISP, SPI, debugWIRE). The system includes a transport device having non-volatile memory and interface electronics for controlling each port interface. The transport device contains the electronic hardware and software necessary to interface to the OEM machine resident programmable device state-machine, be it JTAG, BDM, ISP, SPI or debugWIRE. The transport device eliminates the need to have additional electronic hardware and software designed into the electronic controls of the OEM machine because it interfaces to and exercises the resident state machine in the programmable device resident on the OEM machine through its programming interface port. Differing versions of transport devices may be provided to accommodate differing electrical JTAG, BDM, ISP, SPI or debugWIRE pinouts used by each IC manufacturer. Differing versions of transport devices may also be provided to accommodate the state machine command protocols for each IC manufacturer.

The transport device may contain the PC host program that is auto-loaded into the PC or electronic device when the transport device is connected to it. This further eliminates the need for the user to install programs onto the PC and thus reduces the technical know-how required by the user. Additionally, the user may direct their attention to a web page that is serviced to the PC through the internet and invoke the service to transfer a firmware update to the transport device. This one-step process allows the user to simply connect the transport device to the PC, navigate to the deployment server website, login if necessary, and press a button to invoke the transfer of the firmware update into the transport device. This system, method and device virtually eliminates the need for the user to have technical know-how and also eliminates field errors and additional service calls.

The transport device may contain LED indicators to indicate the status of firmware transfer. Such indications may include information about the success or failure of transfer, data integrity, progress indication of transfer, error code messages in the way the LED flashes or is displayed. The transport device may contain a LCD display for the purpose of indicating information important to the user similar to the LED indicators, and it may also provide capabilities for JTAG, BDM (background debug model), ISP, SPI, debugWIRE, resident bootloaders and other custom protocols designed and supported by the vast number IC manufacturers of programmable devices. It is a high probability that the transport device and method could be used on a high number of existing OEM machines since IC manufacturers have recommended that their standard programming and debug interface port connector be included in designs. This being the case, the deployment method provided by the system, method and device reduces the cost for firmware deployment.

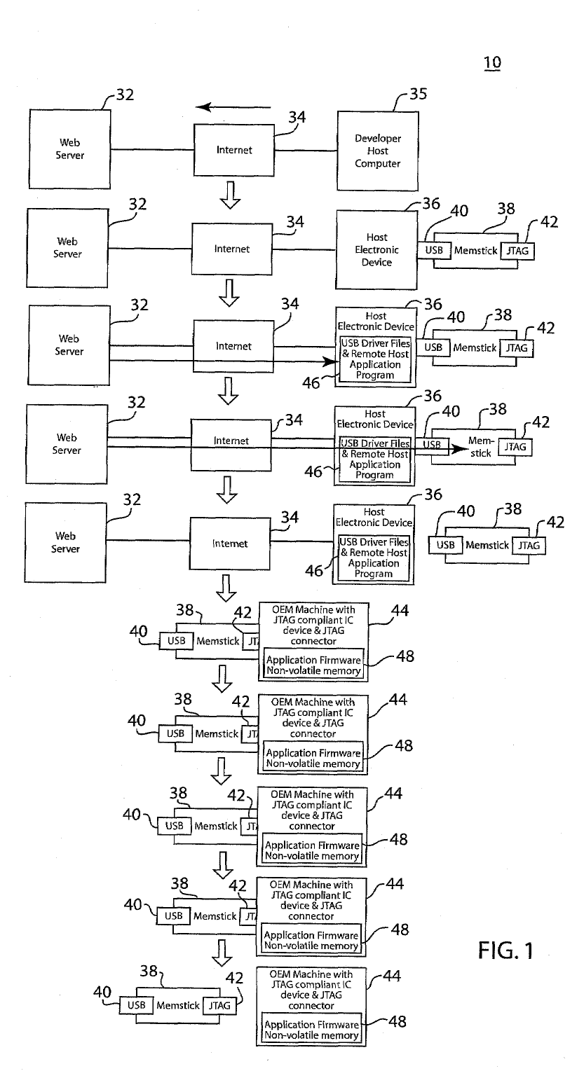

FIG. 1 depicts a block diagram of an embodiment of the firmware deployment method 10. In step 12, a developer utilizes a developer host computer 35 to access a web server 32 over the internet 34. It should be understood that the web server can be replaced in this model with any type of deployment server capable of receiving or delivering information over the internet. It should also be understood that the internet 34 can be replaced in this model with a local area or wide area network, and internet 34 may even be eliminated altogether in an embodiment where the developer host computer 35 is coupled directly to the web server 32. The web server 32 is any server hardware configured to transfer firmware updates when requested by a host electronic device 36. Still in step 12, the developer uploads the firmware update file and any required procedure file to the web server 32 through the internet 34. In step 14, a remote user utilizing a host electronic device 36 connects a transport device, in this embodiment, a memstick 38 to the host electronic device 36 through the first port, in this embodiment, USB port 40. The memstick 38 also includes a second port, in this embodiment, a JTAG port 42, which will be further explained later. The remote user's host electronic device 36 is connected to the web server 32 through the internet 34. It is contemplated that the host electronic device 36 may be an internet enabled device or wireless data device, and that the internet 34 may be replaced with any local area or wide area network.

Still referring to FIG. 1, in step 16, the remote user installs any required USB drivers and application software 46 provided from the web server 32, through the internet 34 and onto the host electronic device 36. In step 18, the host application program 46 connects to the memstick 38, through the USB port 40, and transfers the new firmware and procedure file text files to the memstick 38. It is also contemplated that the memstick 38 can be made with resident drivers and host application programs so that these items need not be retrieved by the host electronic device 36. In step 20, the remote user removes the memstick 38 from the host electronic device 36 by disconnecting the USB port 40 of the memstick 38 from the host electronic device 36.

In step 22, the remote user locates a programming port, in this embodiment, a JTAG port on the OEM machine, wherein the OEM machine includes a set of application firmware to be updated in non-volatile memory 48. The remote user connects the memstick 38 to the OEM machine 44 through the JTAG port 42. After this connection is made in step 22, in step 24, the memstick 38 powers and executes the procedure file and then the memstick 38 employs the JTAG interface protocol and exercises the OEM machine resident JTAG state machine to perform a pre-defined set of operations. In step 26, the memstick 38 uploads and installs the updated firmware into the non-volatile memory 48 of OEM machine 44 through the JTAG port 42. In step 28, the memstick 38 may reboot the OEM machine or the operator may power cycle the OEM machine 44 and the newly installed firmware executes as the new OEM machine application. Lastly, in step 30, the remote user removes the memstick 38 from the OEM machine 44 by disconnecting it from the JTAG port 42. It is also contemplated that the memstick 38 is configured to update a field programmable gate array (FPGA) having the appropriate programming port.

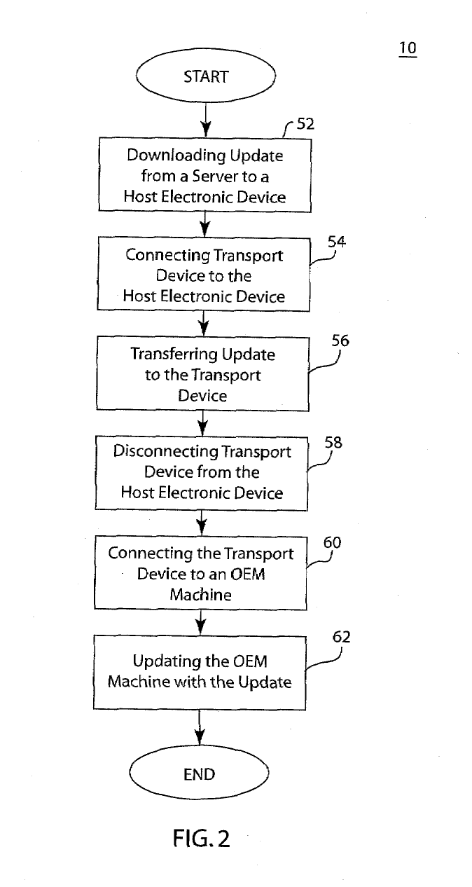

Referring now to FIG. 2, a flowchart of an embodiment of a firmware deployment method is depicted in method 10. In step 52, a firmware update from a server is downloaded to a host electronic device. Once again, the host electronic device is any device that can be connected to a deployment server such as a laptop, cellular phone, PDA, or any other device known in the art. The deployment server may be accessed through an internet, or other local area or wide area network. In step 54, the transport device is connected to the host electronic device. Preferably, the transport device is a memstick, but may be any non-volatile memory device configured to connect to a host electronic device through a standard USB port, or any other port compatible with the host electronic device. In step 56, a firmware update is transferred to the transport device from the host electronic device.

After the firmware update is transferred to the transport device, in step 58 the transport device is disconnected from the host electronic device, and connected to an OEM device in step 60. In step 62, the OEM device is then updated with the updated firmware from step 56.

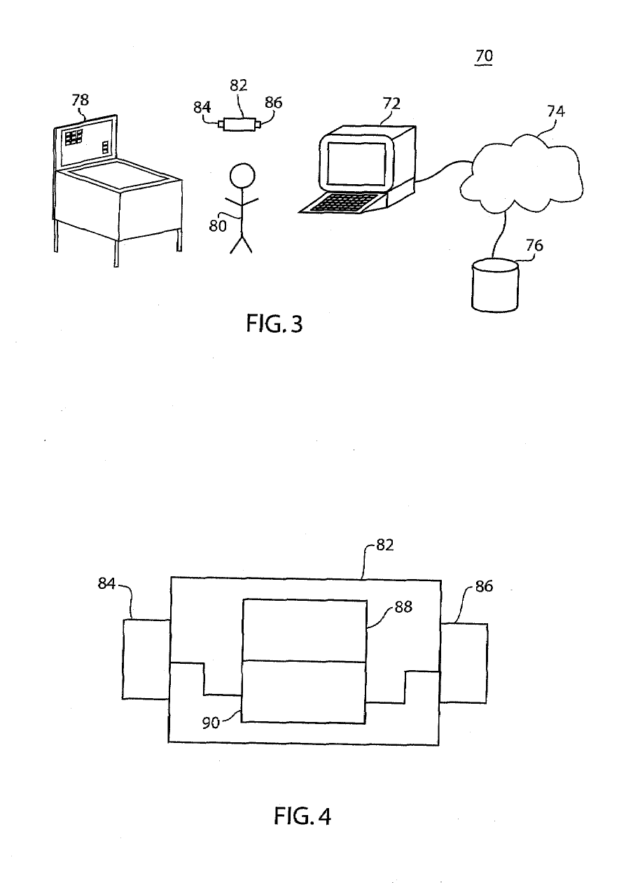

FIG. 3 is a graphical representation of an embodiment of a firmware deployment system 70. Here, a remote user 80, is preferably located on-site where a desired OEM machine 78 requires updated firmware. The user 80 may be an employee where the OEM machine 78 is implemented, or a service technician sent to update the OEM machine 78. A transport device 82, as in this embodiment, a memstick, includes an electronic device interface 86 and a programming interface, such as a JTAG interface 84. The user 80 utilizes a host electronic device 72 to access a central storage device 76 and deployment server (not pictured) through a network 74 such that a firmware update can be downloaded to the host electronic device 72. As discussed previously, the host electronic device 72 may be any device capable of accessing a remote deployment server and firmware updates through a network. Several examples of such electronic devices 72, as well as network 74 examples have been given previously in the specification. Once the updated firmware has been updated to the host electronic device 72, the user connects the transport device 82 to the host electronic device 72 by connecting the transport device with an electronic device interface 86. Alternatively, the transport device 82 may contain the host interface electronics and be configured to connect directly to the network 74. As is stated previously in this specification, the electronic device interface 86 is preferably a USB port, or any other standard port used by the electronic device 72. Once the transport device 82 is connected to the host electronic device 72, the updated firmware may be transferred to the transport device 82, and the transport device 82 may be disconnected from the host electronic device 72. Still referring to FIG. 3, the user may then connect the transport device 82 to the OEM machine 78 through the JTAG interface 84. Once the transport device 82 is connected to the OEM machine 78, the updated firmware may be transferred to the OEM machine 78.

FIG. 4 depicts a transport device 82. Here, in addition to the programming interface 84 and the electronic device interface 86, it should also be noted that the transport device 82 includes a processor or electronic state machine 88 and a non-volatile memory 90 that employs the JTAG interface protocol and the interface protocol necessary to interface to the electronic device. As discussed previously in the discussion of FIG. 1, the processor 88 is utilized to power and execute the procedure file and to upload and install the new firmware into the OEM machine through the JTAG interface 84. The non-volatile memory 90 is utilized to receive and store the firmware updates, as well as to receive and store any USB driver files and remote host application programs.

In a preferred operation, an engineer transfers firmware to a website server using a computer. When at a remote location, a service person uses a host (computer or computerized device) to transfer firmware from a web server to the memstick. The memstick is plugged into the USB port of the host and powered by the host through the USB port. A program on the memstick executes and facilitates communication with the host, through the USB port and the program is executed by the host invoked either by the memstick device or programmatically by the host device. The host program transfers the firmware from the web server to the memstick. The memstick program receives the firmware from the host and data is transferred back and forth between the host and the memstick as required to ensure the integrity of the firmware transfer. The program on the memstick places the firmware into a non-volatile memory file system resident on the memstick and the host and memstick programs finalize the transfer and notifies the user that they may remove the memstick from the host. The memstick performs data integrity tests on the firmware data as necessary and retains the firmware data in the non-volatile memory even with power removed from the device.

During transfer of data from the memstick to the OEM machine, the memstick is physically transported to the OEM machine location. The memstick is plugged into the JTAG port of the OEM machine, that may be powered or non-powered. The memstick may receive power from the powered OEM machine or from an external source. It then executes its program. While the OEM machine executes its normal application program, the memstick begins to control the JTAG state machine on the OEM machine's processor and resets the OEM machine. In this embodiment, the memstick employs the JTAG protocol to exercise the integral JTAG machine present within the microcontroller device on the OEM machine. The memstick may directly manipulate the non-volatile memory through the JTAG interface or it may transfer a small kernel onto the OEM machine's program space, typically the RAM, and execute its code. When a kernel is used on the OEM machine, it begins communicating with the memstick. The memstick and the OEM machine communicate together and mutually work together to transfer the firmware from the memstick into the non-volatile program space of the OEM machine. Integrity tests are performed to insure the successful transfer of the firmware into the program space of the OEM machine. Upon completion of the transfer and acceptable integrity tests, the OEM processor is reset, and upon power-up, the OEM processor executes the newly installed firmware. The memstick is removed from the OEM machine with a successful firmware deployment. Tests are performed on the OEM machine to ensure a successful firmware deployment.

The memstick may contain a clock calendar to use for time/date stamping information. The web interface for firmware deployment can work with the memstick device to track the following information: the OEM machine firmware deployment status such as serial number data, deployment success/failure by machine and date/time information of deployment history; memstick information which includes tracking serial number data and number of installs; and remote authentication of memstick which tracks allow/disallow use of memstick and allow/disallow use for specific machines.

JTAG was originally developed for boundary scan testing of circuit boards. Therefore, it is conceivable that the memstick could be used for the sole purpose of testing and diagnosing the electronics within an OEM machine. Another use for the memstick is collecting data from the OEM machine and transferring the data to designated individuals at remote locations. The memstick could also be connected to the host and the OEM machine simultaneously and controlled from a remote location. This embodiment could be useful for remote diagnostics, data collection, programming, etc. This is a low cost solution that could replace more expensive networking options. The memstick could contain its own host and be capable of connecting to a communications medium by which it connects to a remote deployment server. The memstick could also contain wireless capabilities such as infra-red, or RF. The memstick could also be designed to interface to a cell phone port, PDA or wireless data device which would allow service technicians to only carry their wireless device and memstick device to a site and download the data through the wireless device to the memstick. An interface card that serves to interconnect the memstick or replace it altogether could be plugged into a PDA for the purpose of updating the OEM machine software. The memstick's own internal program or kernel can be reprogrammed by this system and method so that it can be configured or customized to interface to different OEM machines or platforms.

The present invention has been described in terms of specific embodiments incorporating details to facilitate the understanding of the principals of construction and operation of the invention. Such reference herein to specific embodiments and details thereof is not intended to limit the scope of the claims appended hereto. It will be apparent to those skilled in the art that modifications may be made in the embodiment chosen for illustration without departing from the spirit and scope of the invention.

What is claimed is:

1. A system for deploying firmware updates to an OEM machine, the system comprising:
a transport device including:
a first port;
a second port;
and a non-volatile memory; and
an electronic device configured to access and retrieve a firmware update, wherein the first port of the transport device is configured to interface with the electronic device, and further wherein the electronic device is configured to transfer the firmware update to the non-volatile memory through the first port when the transport device is removably coupled to the electronic device,
wherein the second port is configured to interface with the OEM machine, such that when the transport device is decoupled from the electronic device and coupled to the OEM machine, the firmware update is transferred to the OEM machine.

2. The system as claimed in claim 1, wherein the transport device further includes a processor or state-machine electronics configured to facilitate the retrieval and transfer of the firmware update from the electronic device to the OEM machine.

3. The system as claimed in claim 1, wherein the electronic device is configured to access a network.

4. The system as claimed in claim 3, wherein the network is any of: the internet; a wide area network; and a local area network.

5. The system as claimed in claim 3, wherein the electronic device accesses the firmware update through the network.

6. The system as claimed in claim 5, further comprising any one of a deployment server; a web server, a file server configured to provide the firmware update to the electronic device.

7. The system as claimed in claim 1, wherein the electronic device is an internet enabled device.

8. The system as claimed in claim 1, wherein the electronic device is a wireless data device.

9. The system as claimed in claim 1, wherein the first port is any one of a USB port; a firewire port; a printer port; a serial port, a powered ethernet port and a phone port.

10. The system as claimed in claim 1, wherein the second port is any one of a JTAG; an ISP, a SPI; a BDM, a resident bootloader, a serial UART, and a debugWIRE port.

11. The system as claimed in claim 1, wherein the transport device is further configured to update a field programmable gate array.

12. The system as claimed in claim 1, wherein the transport device is remotely configurable to change its function to that as claimed in claim 10.

13. A method of deploying firmware updates to an embedded processing machine, the method comprising:
retrieving a firmware update with an electronic device,
connecting a transport device to the electronic device with a first port;
transferring the firmware update to the transport device through the first port;
disconnecting the transport device from the electronic device;
connecting the transport device to an OEM machine with a second port; and
transferring the firmware update to the OEM machine through the second port.

14. The method as claimed in claim 13, wherein the transport device further includes one of a processor or state machine electronics configured to facilitate the retrieval and transfer of the firmware update from the electronic device to the OEM machine.

15. The method as claimed in claim 13, wherein the retrieving step includes the electronic device accessing a network.

16. The method as claimed in claim 15, wherein the network is any of: the internet; a wide area network; and a local area network.

17. The method as claimed in claim 15, wherein the electronic device retrieves the firmware update from any one of a deployment server; a web server; a file server.

18. The method as claimed in claim 13, wherein the electronic device is an internet enabled device.

19. The method as claimed in claim 13, wherein the electronic device is a wireless data device.

20. The method as claimed in claim 13, wherein the first port is any one of a USB port; and a firewire port; a printer port; a serial port; a powered ethernet port; and a phone port.

21. The method as claimed in claim 13, wherein the second port is any one of a JTAG; an ISP; a SPI; a BDM; a resident bootloader; a serial UART; and a debugWIRE port.

22. The method as claimed in claim 13, wherein the transport device is further configured to update a field programmable gate array.

23. The method as claimed in claim 12, wherein the transport device is remotely configurable to change its function to that as claimed in claim 21.

24. A transport device for deploying a firmware update to an OEM machine, the transport device comprising:
a first port configured for coupling to a network service media, such that when the first port is coupled to the network service media, a firmware update is transferred from a deployment server such as a web server to the transport device;
a non-volatile memory coupled to the first port, and configured to receive the firmware update from the network service media through the first port;
a second port coupled to the non-volatile memory, and configured to couple with an OEM machine, such that when the transport device receives the firmware update, the transport device is decoupled from the network service media, and coupled to the OEM machine, further wherein the transport device transfers the firmware update from the non-volatile memory device to the OEM machine through the second port; and
any of a processor or state-machine electronics configured to facilitate the transfer of the firmware update from the electronic device to the OEM machine, wherein the processor or state-machine electronics remotely configurable to employ any one of a JTAG; an ISP; a SPI; a BDM; and a debugWIRE port.

25. A transport device for deploying a diagnostic test routine onto an OEM machine, the transport device comprising:
a first port configured for coupling to an electronic device, such that when the first port is coupled to the electronic device, a diagnostic test program is transferred from the electronic device to the transport device;
a non-volatile memory coupled to the first port, and configured to receive the diagnostic test software from the electronic device through the first port;
a second port configured for coupling to a JTAG port coupled to the non-volatile memory, and further configured to couple with an OEM machine, such that when the transport device receives the diagnostic test software update, the transport device is decoupled from the electronic device, and coupled to the OEM machine, further wherein when the transport device is coupled to the OEM machine, transport device invokes the diagnostic test routines held within the transport device and performs a set of tests upon the OEM machine through the second port using a JTAG protocol resident on the OEM machine; and
any of a processor or state-machine electronics configured to facilitate the execution of the diagnostic test software resident in non-volatile memory through the second port when attached to the OEM machine.
